(19) United States
(12) Patent Application Publication
(10) Pub. No.: US 2018/0352601 A1
(43) Pub. Date: Dec. 6, 2018

(54) METHOD FOR COMMUNICATING IN MOBILE COMMUNICATION SYSTEM AND APPARATUS FOR THE SAME

(71) Applicant: Electronics and Telecommunications Research Institute, Daejeon (KR)

(72) Inventors: Hyun Seo PARK, Daejeon (KR); Eun Kyung KIM, Daejeon (KR); Tae Joong KIM, Daejeon (KR); An Seok LEE, Daejeon (KR); Yu Ro LEE, Daejeon (KR); Hyun LEE, Daejeon (KR); Hee Soo LEE, Daejeon (KR)

(73) Assignee: Electronics and Telecommunications Research Institute, Daejeon (KR)

(21) Appl. No.: 15/994,027

(22) Filed: May 31, 2018

(30) Foreign Application Priority Data
May 31, 2017 (KR) 10-2017-0067972
Jun. 26, 2017 (KR) 10-2017-0080532
May 23, 2018 (KR) 10-2018-0058399

(51) Int. Cl. H04W 76/19; H04W 74/00; H04W 76/27; H04L 5/00; H04W 36/08

(52) U.S. Cl. CPC H04W 76/19; H04W 74/006; H04W 36/30; H04L 5/0055; H04W 36/08; H04W 76/27

(57) ABSTRACT

Disclosed is an operation method of a terminal in a mobile communication system. The operation method may comprise starting a T310 timer when a physical layer out-of-synchronization occurs in a PDCCH transmitted from a first base station; confirming that an RLF occurs when the PDCCH does not transition to a physical layer in-sync state until the T310 timer expires; performing re-establishment of PDCP layers and RLC layers for all radio bearers except an SRB0; suspending all the radio bearers except the SRB0; performing RRC connection re-establishment with a second base station selected through cell selection; and resuming all the radio bearers when the RRC connection re-establishment with the second base station succeeds.

### CROSS-REFERENCE TO RELATED APPLICATIONS

This application claims priorities to Korean Patent Applications No. 10-2017-0067972 filed on May 31, 2017, No. 10-2017-0080532 filed on Jun. 26, 2017, and No. 10-2018-0058399 filed on May 23, 2018 in the Korean Intellectual Property Office (KIPO), the entire contents of which are hereby incorporated by reference.

### BACKGROUND

### 1. Technical Field

The present disclosure relates to a mobile communication system, and more specifically, to a technique for low-latency data transmission and reception in the mobile communication system.

### 2. Related Art

A fifth generation (5G) mobile communication aiming at giga bps (Gbps) class support of at least 10 to 100 times data transmission rate than a fourth generation (4G) mobile communication may use not only existing mobile communication frequency bands but also several tens giga Hertz (Ghz) frequency band. The 5G mobile communication supports an enhanced mobile broadband (eMBB) for supporting a high-speed data transmission rate but also a massive machine type communication (mMTC) and an ultra-reliable low latency communication (URLLC).

In order to support the URLLC, a transmission time interval (TTI) shorter than that of the prior art and techniques for reducing a transmission latency are required, and techniques for utilizing frequency/time/space diversity are also required to achieve the high reliability.

### SUMMARY

Accordingly, embodiments of the present disclosure provide an operation method of a terminal for minimizing data transmission latency and securing data transmission reliability in a mobile communication system.

In order to achieve the objective of the present disclosure, an operation method of a terminal in a mobile communication system may comprise starting a T310 timer when a physical layer out-of-synchronization occurs in a physical downlink control channel (PDCCH) transmitted from a first base station; confirming that a radio link failure (RLF) occurs when the PDCCH does not transition to a physical layer in-sync state until the T310 timer expires; performing re-establishment of packet data convergence protocol (PDCP) layers and a radio link control (RLC) layers for all radio bearers except a signaling radio bearer 0 (SRB0); suspending all the radio bearers except the SRB0; performing a radio resource control (RRC) connection re-establishment with a second base station selected through cell selection; and resuming all the radio bearers when the RRC connection re-establishment with the second base station succeeds.

The operation method may further comprise transferring data transferred from the first base station to an upper layer of the RLC layer at a time determined through control of a RRC layer, and selectively transferring the data to an upper layer of the PDCP layer.

The operation method may further comprise, when data is not normally received in spite of a retransmission request to the first base station according to a predetermined criterion, transferring data transferred from the first base station to an upper layer of the RLC layer, and selectively transferring the data transferred from the first base station to an upper layer of the PDCP layer.

The operation method may further comprise, when an RLF occurs with the first base station, transmitting information indicating the RLF to the first base station through the second base station.

The operation method may further comprise transmitting information indicating an identifier (ID) of the second base station selected through cell selection to the first base station.

The operation method may further comprise transmitting information indicating the RLF to the first base station through a secondary cell carrier, wherein the first base station is a master base station for carrier aggregation.

The operation method may further comprise transmitting information indicating the RLF to the first base station through a secondary cell group (SCG), wherein the first base station is a master base station for dual connectivity.

The operation method may further comprise performing re-establishment of PDCP layers and RLC layers of all radio bearers excluding an SRB0 with the master base station; and performing data transmission and reception with the master base station without suspending all the radio bearers except the SRB0.

In order to achieve the objective of the present disclosure, an operation method of a terminal in a mobile communication system may comprise receiving, by a first radio link control (RLC) receiver and a second RLC receiver, a same data respectively transmitted from a first RLC transmitter and a second RLC transmitter of a base station; transmitting information indicating normal reception to the first RLC transmitter that has transmitted the data when at least one of the first RLC receiver and the second RLC receiver normally receives the data; and receiving, by at least one of the first RLC receiver and the second RLC receiver, an RLC protocol data unit (PDU) including a sequence number of a discarded RLC PDU from at least one of the first RLC transmitter and the second RLC transmitter that has not received the information indicating normal reception.

The operation method may further comprise receiving, by at least one of the first RLC receiver and the second RLC receiver that has not transmitted the information indicating normal reception, an RLC PDU comprising only an RLC header from at least one of the first RLC transmitter and the second RLC transmitter that has not received the information indicating normal reception.

A packet data convergence protocol (PDCP) layer of the base station may inform the first RLC transmitter and the second RLC transmitter that a PDCP PDU of the PDCP layer is duplicated, and set a polling bit in an RLC PDU including the PDCP PDU.

In order to achieve the objective of the present disclosure, an operation method of a terminal in a mobile communication system may comprise transmitting a packet data convergence protocol (PDCP) protocol data unit (PDU) including information on an importance per Internet Protocol (IP) packet to a radio link control (RLC) layer; transmitting an RLC PDU including the information on the importance per IP packet to a medium access control (MAC) layer; transmitting a buffer status report (BSR) to a base station; receiving an uplink grant from the base station; and performing discard of the RLC PDU based on the importance per IP packet according to a predetermined criterion when the PDCP PDU to be transmitted through an uplink radio resource allocated through the uplink grant is not transmitted for a predetermined period of time.

Quality of Service (QoS) may be assigned to each packet differentially according to the importance per IP packet.

The MAC layer may immediately trigger the BSR when data having high importance exists.

When a plurality of acknowledgement (ACK) packets exist for a transmission control protocol (TCP) connection to be transmitted to the base station, the PDCP layer may discard ACK packets other than a most recently generated ACK packet.

A subchannel may be assigned to each logical channel for each IP packet to which QoS is assigned according to the importance information per IP packet.

A different priority and a discard timer may be configured for each subchannel.

According to the embodiments of the present disclosure, the ultra-reliable low latency communication (URLLC) can be performed through data transmission and reception in a mobile communication system, which reflect efficient management of redundant transmission and priority setting of data transmission.

### BRIEF DESCRIPTION OF DRAWINGS

Embodiments of the present disclosure will become more apparent by describing in detail embodiments of the present disclosure with reference to the accompanying drawings, in which:

FIG. 1 is a conceptual diagram illustrating a first embodiment of a communication system;

FIG. 2 is a block diagram illustrating a first embodiment of a communication node constituting a communication system;

FIG. 3 is a conceptual diagram illustrating a radio interface protocol structure in the conventional 3GPP LTE and LTE-A mobile communication systems;

FIG. 4 is a conceptual diagram for explaining an RRC state and an RRC connection method according to the prior art;

FIG. 5 is a sequence chart illustrating an RRC connection re-establishment procedure according to the prior art;

FIG. 6 is a sequence chart illustrating an RRC connection re-establishment procedure according to an embodiment of the present disclosure;

FIG. 7 is a conceptual diagram illustrating data transmission through RRC connection re-establishment of a terminal supporting dual connectivity according to an embodiment of the present disclosure;

FIG. 8 is a conceptual diagram illustrating data transmission through RRC connection re-establishment of a terminal supporting carrier aggregation according to an embodiment of the present disclosure;

FIG. 9 is a conceptual diagram for explaining a PDCP PDU duplicate transmission according to the prior art;

FIG. 10 is a conceptual diagram illustrating a PDCP PDU duplicate transmission method according to an embodiment of the present disclosure;

FIG. 11 is a conceptual diagram illustrating data transmission using QoS settings per IP flow according to the prior art;

FIG. 12 is a conceptual diagram illustrating data transmission using QoS settings per IP flow according to an embodiment of the present disclosure;

FIG. 13A is a conceptual diagram illustrating a slot-based PDCCH monitoring according to the prior art;

FIG. 13B is a conceptual diagram illustrating a PDCCH monitoring when a mini-slot according to the prior art is applied; and

FIG. 14 is a sequence chart for explaining a mini-slot based PDCCH monitoring according to an embodiment of the present disclosure.

### DETAILED DESCRIPTION

Embodiments of the present disclosure are disclosed herein. However, specific structural and functional details disclosed herein are merely representative for purposes of describing embodiments of the present disclosure, however, embodiments of the present disclosure may be embodied in many alternate forms and should not be construed as limited to embodiments of the present disclosure set forth herein.

Accordingly, while the present disclosure is susceptible to various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, embodiments of the present disclosure will be described in greater detail with reference to the accompanying drawings. In order to facilitate general understanding in describing the present disclosure, the same components in the drawings are denoted with the same reference signs, and repeated description thereof will be omitted.

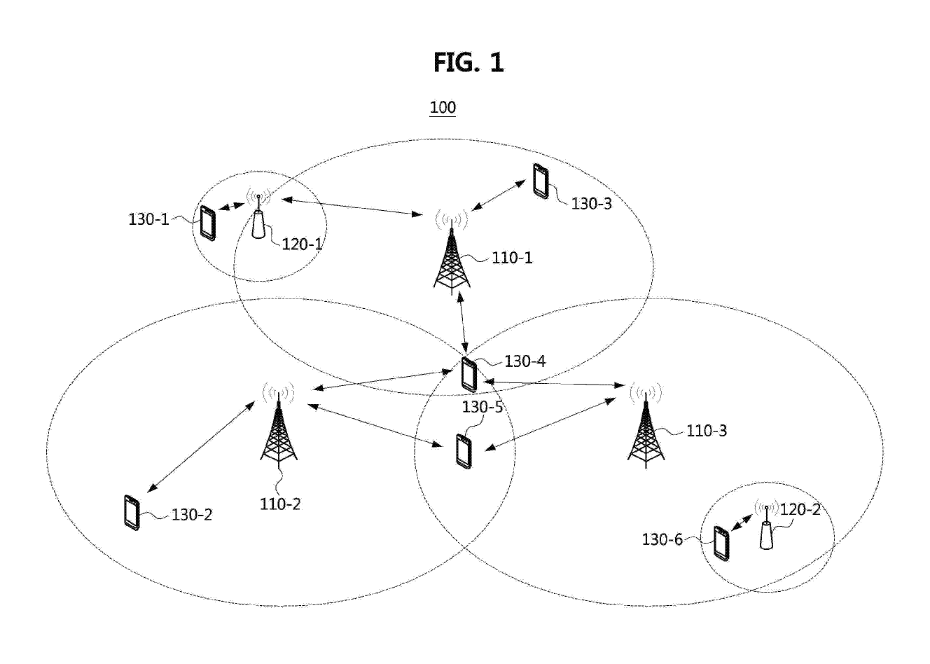

FIG. 1 is a conceptual diagram illustrating a first embodiment of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. Also, the communication system 100 may comprise a core network (e.g., a serving gateway (S-GW), a packet data network (PDN) gateway (P-GW), a mobility management entity (MME), and the like).

The plurality of communication nodes may support 4^{th} generation (4G) communication (e.g., long term evolution (LTE), LTE-advanced (LTE-A)), or 5^{th} generation (5G) communication defined in the 3^{rd} generation partnership project (3GPP) standard. The 4G communication may be performed in a frequency band below 6 gigahertz (GHz), and the 5G communication may be performed in a frequency band above 6 GHz. For example, for the 4G and 5G communications, the plurality of communication nodes may support at least one communication protocol among a code division multiple access (CDMA) based communication protocol, a wideband CDMA (WCDMA) based communication protocol, a time division multiple access (TDMA) based communication protocol, a frequency division multiple access (FDMA) based communication protocol, an orthogonal frequency division multiplexing (OFDM) based communication protocol, an orthogonal frequency division multiple access (OFDMA) based communication protocol, a single carrier PUMA (SC-FDMA) based communication protocol, a non-orthogonal multiple access (NOMA) based communication protocol, and a space division multiple access (SDMA) based communication protocol. Also, each of the plurality of communication nodes may have the following structure.

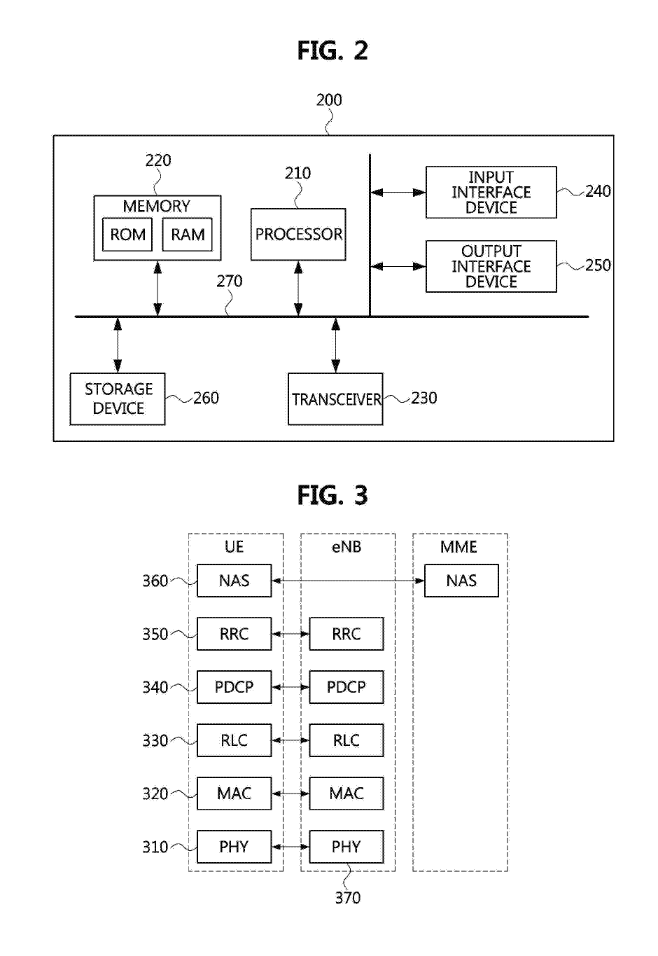

FIG. 2 is a block diagram illustrating a first embodiment of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to cell coverage of the first base station 110-1. Also, the second terminal 130-2, the fourth terminal 130-4, and the fifth terminal 130-5 may belong to cell coverage of the second base station 110-2. Also, the fifth base station 120-2, the fourth terminal 130-4, the fifth terminal 130-5, and the sixth terminal 130-6 may belong to cell coverage of the third base station 110-3. Also, the first terminal 130-1 may belong to cell coverage of the fourth base station 120-1, and the sixth terminal 130-6 may belong to cell coverage of the fifth base station 120-2.

Here, each of the plurality of base stations 110-1, 110-2, 110-3, 120-1, and 120-2 may refer to a Node-B, a evolved Node-B (eNB), a base transceiver station (BTS), a radio base station, a radio transceiver, an access point, an access node, or the like. Also, each of the plurality of terminals 130-1, 130-2, 130-3, 130-4, 130-5, and 130-6 may refer to a user equipment (UE), a terminal, an access terminal, a mobile terminal, a station, a subscriber station, a mobile station, a portable subscriber station, a node, a device, or the like.

Meanwhile, each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul or a non-ideal backhaul, and exchange information with each other via the ideal or non-ideal backhaul. Also, each of the plurality of base stations 110-1, 110-2, 110-3, 120-1, and 120-2 may be connected to the core network through the ideal or non-ideal backhaul. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

Also, each of the plurality of base stations 110-1, 110-2, 110-3, 120-1, and 120-2 may support a multi-input multi-output (MIMO) transmission (e.g., a single-user MIMO (SU-MIMO), a multi-user MIMO (MU-MIMO), a massive MIMO, or the like), a coordinated multipoint (CoMP) transmission, a carrier aggregation (CA) transmission, a transmission in unlicensed band, a device-to-device (D2D) communications (or, proximity services (ProSe)), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2 (i.e., the operations supported by the plurality of base stations 110-1, 110-2, 110-3, 120-1, and 120-2). For example, the second base station 110-2 may transmit a signal to the fourth terminal 130-4 in the SU-MIMO manner, and the fourth terminal 130-4 may receive the signal from the second base station 110-2 in the SU-MIMO manner. Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner.

The first base station 110-1, the second base station 110-2, and the third base station 110-3 may transmit a signal to the fourth terminal 130-4 in the CoMP transmission manner, and the fourth terminal 130-4 may receive the signal from the first base station 110-1, the second base station 110-2, and the third base station 110-3 in the CoMP manner. Also, each of the plurality of base stations 110-1, 110-2, 110-3, 120-1, and 120-2 may exchange signals with the corresponding terminals 130-1, 130-2, 130-3, 130-4, 130-5, or 130-6 which belongs to its cell coverage in the CA manner. Each of the base stations 110-1, 110-2, and 110-3 may control D2D communications between the fourth terminal 130-4 and the fifth terminal 130-5, and thus the fourth terminal 130-4 and the fifth terminal 130-5 may perform the D2D communications under control of the second base station 110-2 and the third base station 110-3.

Hereinafter, low-latency data transmission techniques in a mobile communication system will be described. Here, even when a method (e.g., transmission or reception of a signal) to be performed in a first communication node among communication nodes is described, a corresponding second communication node may perform a method ((E.g., reception or transmission of the signal) corresponding to the method performed in the first communication node. That is, when an operation of a terminal is described, a corresponding base station may perform an operation corresponding to the operation of the terminal. Conversely, when an operation of the base station is described, the corresponding terminal may perform an operation corresponding to the operation of the base station.

FIG. 3 is a conceptual diagram illustrating a radio interface protocol structure in the conventional 3GPP LTE and LTE-A mobile communication systems.

Referring to FIG. 3, layers of a radio interface protocol between a terminal (i.e., user equipment (UE)) and a base station (i.e., e-Node B (eNB)) (including a core network) may be classified into a first layer (i.e., L1 layer), a second layer (i.e., L2 layer) and a third layer (i.e., L3 layer) based on three lower layers of an open system interconnection (OSI) model. The radio interface protocol between the terminal and the base station may be horizontally divided into a physical layer, a data link layer and a network layer, and vertically divided into a protocol stack (i.e., control plane) for transmitting control information and a protocol stack (i.e., user plane) for transmitting data (also referred to as user data or traffic).

The L1 layer may be a physical (PHY) layer 310. The PHY layer 310 may provide information (data and control information) transmission services to an upper layer through at least one physical channel. The PHY layer 310 may be connected to a media access control (MAC) layer 320, which is an upper layer, through at least one transport channel (i.e., a physical channel is mapped to a transport channel). Data and control information may be transmitted between the MAC layer 320 and the PHY layer 310 via at least one transport channel. Data and control information between different PHY layers, that is, between the PHY layers 310 of the terminal and the PHY layer 370 of the base station, may be transmitted using radio resources through the at least one physical channel.

In the PHY layer 310, at least one physical control channel may be used to transmit control information in addition to data. For example, a physical downlink control channel (PDCCH) may be used to transmit information on resource allocation of a paging channel (PCH) and a downlink shared channel (DL-SCH), and information on a hybrid automatic repeat request (HARQ) related to the DL-SCH. Also, the PDCCH may include an uplink (UL) grant, which is information on resource allocation for UL transmission. A physical control format indicator channel (PCFICH) may transmit information on the number of OFDM symbols used for transmission of the PDCCH to the terminal. A physical hybrid ARQ indicator channel (PHICH) may be used to convey HARQ acknowledgment or negative-acknowledgment (ACK/NACK) information for an uplink shared channel (UL-SCH). A physical uplink control channel (PUCCH) may be used to transmit UL control information such as HARQ ACK/NACK for downlink transmission, a scheduling request, and a channel quality indicator (CQI).

The physical channels may be composed of a plurality of subframes in the time domain and a plurality of subcarriers in the frequency domain. One subframe may consist of a plurality of resource blocks (RBs), and one RB may be composed of a plurality of symbols (one subframe may be composed of a plurality of symbols in the time domain) and a plurality of subcarriers. Also, each subframe may use specific subcarriers of specific symbols of the corresponding subframe for transmission of the PDCCH. For example, the first symbol of the subframe may be used for transmitting the PDCCH. A transmission time interval (TTI), which is a unit time during which data is transmitted, may be equal to the length of one subframe, and the length of one subframe may be 1 ms.

As described above, the PHY layer 310 may be connected with the MAC layer 320, which is an upper layer, through at least one transport channel. The at least one transport channel may be classified into a common transport channel and a dedicated transport channel according to whether each channel is shared or not. The downlink (DL) transport channels may include a broadcast channel (BCH) for transmitting system information, a paging channel (PCH) for transmitting a paging message, the DL-SCH for transmitting user data or control information, and the like. The DL-SCH may support HARQ, transmission power control, dynamic link adaptation using adaptive modulation and coding scheme, dynamic or semi-static resource allocation, and the like. Traffic or control information of a multimedia broadcast and multicast service (MBMS) may be transmitted through a multicast channel (MCH).

The UL transport channels may include a random access channel (RACH) used for initial control message transmission and initial access to a cell, the UL-SCH for transmitting user data or control information, and the like. The UL-SCH may support HARQ, transmission power control, dynamic link adaptation using adaptive modulation and coding scheme, and the like. The RACH may be typically used for the initial access to the cell.

The MAC layer 320 corresponding to the L2 layer may provide services to an upper layer (i.e., a radio link control (RLC) layer) through at least one logical channel. The MAC layer 320 may provide a mapping function from a plurality of logical channels to a plurality of transport channels (i.e., a logical channel may be located above a transport channel and may be mapped to the transport channel). Also, the MAC layer 320 may provide a logical channel multiplexing function by mapping from a plurality of logical channels to one transport channel. The logical channel may be classified into a control logical channel for transferring information on the control plane and a traffic logical channel for transferring information on the user plane according to the type of information to be transmitted. That is, the type of the logical channel may be defined for each transmission service provided by the MAC layer 320.

Specifically, the control logical channel may be used only for information transfer of the control plane. The control logical channels provided by the MAC layer 320 may include a broadcast control channel (BCCH), a paging control channel (PCCH), a common control channel (CCCH), a multicast control channel (MCCH), and a dedicated control channel (DCCH). The BCCH may be a logical channel for broadcasting system control information. The PCCH may be a logical channel used for transmitting paging information and for paging a terminal whose location in unit of a cell is unknown to a base station. The CCCH may be used by a terminal when the terminal does not have a radio resource control (RRC) connection with a base station. The MCCH may be a one-to-many downlink logical channel used for transmitting MBMS control information from a base station to terminals. The DCCH may be a one-to-one bi-directional logical channel used to transmit dedicated control information between the terminal in the RRC connection state and the network.

The traffic logical channel may be used only for information transfer of the user plane. The traffic logical channels provided by the MAC layer 310 may include a dedicated traffic channel (DTCH) and a multicast traffic channel (MTCH). The DTCH may be a one-to-one channel used for transmission of user information of one terminal, and may exist in both uplink and downlink. The MTCH may be a one-to-many downlink logical channel for transmitting data (traffic) from a base station to terminals.

The RLC layer 330 may belong to the L2 layer. The function of the RLC layer 330 may include resizing of data by segmentation and concatenation of data received from an upper layer so that the data becomes suitable for a lower layer to transmit. In order to guarantee various quality of service (QoS) required by a radio bearer (RB), the RLC layer 330 may provide three operation modes including a transparent mode (TM), an unacknowledged mode (UM), and an acknowledged mode (AM). The AM RLC provides retransmission through automatic repeat request (ARQ) for reliable data transmission. Meanwhile, the functions of the RLC layer 330 may be implemented with functional blocks in the MAC layer 310, and in this case, the RLC layer 330 may not exist.

The packet data convergence protocol (PDCP) layer 340 may also belong to the L2 layer. The PDCP layer 340 may provide a header compression function that reduces unnecessary control information so that data transmitted using IP packets such as internet protocol version 4 (IPv4) or internet protocol version 6 (IPv6) packets are efficiently transmitted on a radio interface having a relatively small bandwidth. The header compression may increase transmission efficiency in the radio channel by transmitting only the necessary information in the header of the data. Also, the PDCP layer 340 may provide security functions. The security functions may include ciphering to prevent third party inspections and integrity protection to prevent third party data manipulation.

The RRC layer 350 may belong to the L3 layer. The RRC layer 350 located at the lowermost part of the L3 layer may be defined only in the control plane. The RRC layer 350 may control radio resources between the terminal and the base station. To this end, the terminal and the network may exchange RRC messages through the RRC layer 350. The RRC layer 350 may be responsible for controls on the logical, transport and physical channels in connection with configuration, re-configuration and release of radio bearers (RBs). The RB may be a logical path provided by the L1 and L2 layers for data transfer between the terminal and the base station. That is, the RB may mean a service provided by the L2 layer for data transmission between the terminal and the base station. The fact that the RB is configured may mean to define the characteristics of the radio protocol layer and the channel to provide a specific service, and to determine specific parameters and operation methods for the specific service. The RB may be classified into a signaling RB (SRB) and a data RB (DRB). The SRB is used as a path for transmitting RRC messages in the control plane, and the DRB is used as a path for transmitting user data in the user plane.

The non-access stratum (NAS) layer 360 located at the top of the RRC layer 350 may perform functions such as session management and mobility management.

Referring back to FIG. 3, the RLC layer 330 and the MAC layer 320 of the control plane may perform functions such as scheduling, ARQ, and HARQ. The RRC layer 350 may perform functions such as broadcasting, paging, RRC connection management, RB control, mobility functions, and terminal measurement reporting/control. The NAS control protocol of the NAS layer 360 may perform functions such as system architecture evolution (SAE) bearer management, authentication, LTE_IDLE mobility handling, paging initiation in LTE_IDLE, and security control for signaling between the terminal and a gateway (a detailed description will be omitted). The RLC layer and the MAC layer of the user plane may perform the same functions as the functions in the control plane (FIG. 3 illustrates the radio interface protocols of the control plane). The PDCP layer may perform user plane functions such as header compression, integrity protection, and ciphering. Then, an RRC state and an RRC connection method of the terminal will be described.

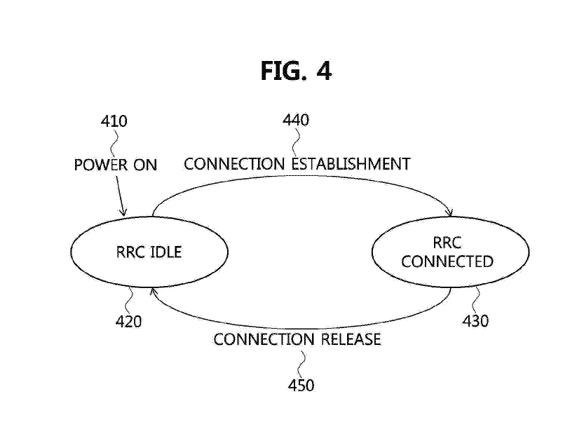

FIG. 4 is a conceptual diagram for explaining an RRC state and an RRC connection method according to the prior art. Referring to FIG. 4, an RRC state change according to a power-on 410 of the terminal is illustrated.

The RRC state may indicate whether the RRC layer of the terminal is logically connected to the RRC layer of the base station (including the core network). The RRC state may be classified into an RRC connected state (RRC_CONNECTED state) 430 and an RRC idle state (RRC_IDLE state) 420. When an RRC connection between the RRC layer of the terminal and the RRC layer of the base station is established, the terminal transitions to the RRC connected state 430, otherwise the terminal is in the RRC idle state 420. Since the RRC connection is established with the base station in the case of the terminal in the RRC connected state 430, the base station may identify the existence of the terminal and effectively control the terminal. On the other hand, the base station cannot identify the terminal in the RRC idle state 420, and the core network manages the terminal in unit of a tracking area larger than a cell. That is, the terminal in the RRC idle state 420 may be identified only in unit of a larger area. In order to receive normal mobile communication services such as voice or data communications, the terminal should transition to the RRC connected state 430.

In the RRC Idle state 420, the terminal may receive broadcast of system information and paging information while the terminal performs discontinuous reception (DRX) configured by the NAS. Also, the terminal is allocated an identifier (ID) for uniquely indicating the terminal in the tracking area, and may perform a public land mobile network (PLMN) selection and cell reselection.

In the RRC connected state 430, the terminal may be capable of taking RRC connection and RRC contexts of the base station from the base station, and capable of transmitting and/or receiving data to and from the base station. Also, the terminal may report channel quality information and feedback information to the base station. In the RRC connected state 430, the base station may identify the cell to which the terminal belongs. Thus, the base station may transmit and/or receive data to and from the terminal. In the RRC idle state 420, the terminal may specify a DRX cycle. Specifically, the terminal may monitor a paging signal during a specific paging occasion for each terminal-specific paging DRX cycle. The paging occasion may be a time interval during which the paging signal is transmitted. The terminal has its own paging occasion. A paging message may be transmitted across all cells belonging to the same tracking area.

When a user powers on the terminal (410), the terminal searches an appropriate cell and then remains in the RRC idle state 420 in the corresponding cell. When it is necessary to establish an RRC connection, the terminal in the RRC idle state may establish an RRC connection with the RRC layer of the base station through an RRC connection procedure, and transition to the RRC connected state 430. For example, when the terminal in the RRC idle state 420 requires uplink data transmission due to a user's call attempt or when the terminal in the RRC idle 420 receives a paging message from the base station and desires to transmit a response to the paging message, the terminal may perform a connection establishment procedure 440 to establish an RRC connection with the base station so as to transition from the RRC idle state 420 to the RRC connected state 430. On the other hand, a connection release 450 may be performed to transition from the RRC connected state 430 to the RRC idle state 420. As described above, the radio interface protocol and RRC state changes that are the basis of data transmission between the base station and the terminal have been described. Next, an RRC connection re-establishment to overcome a radio link failure (RLF) due to a physical layer error or the like will be described. Then, an RRC connection re-establishment procedure according to the related art will be described.

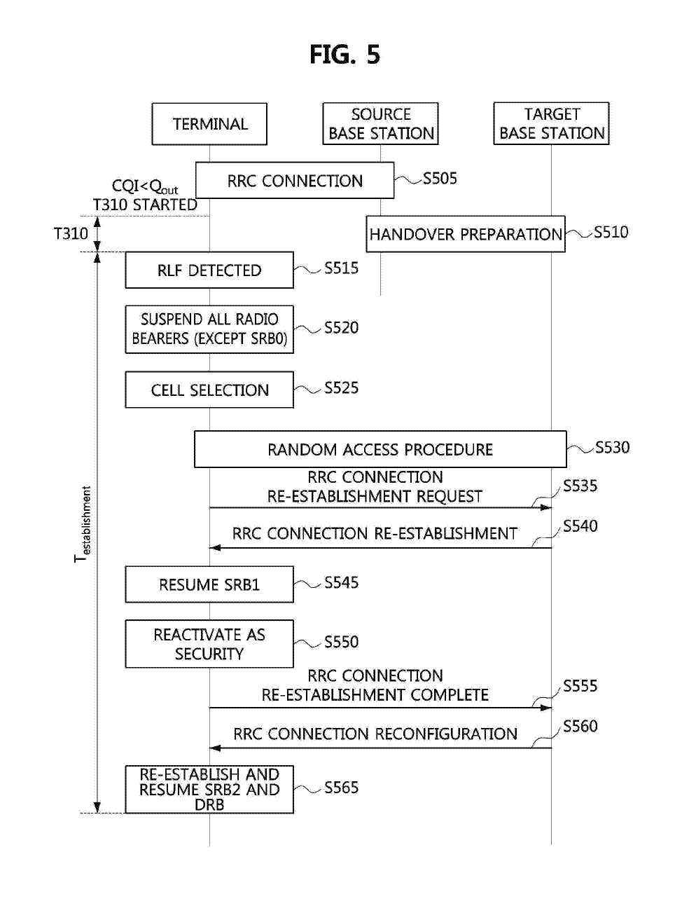

FIG. 5 is a sequence chart illustrating an RRC connection re-establishment procedure according to the prior art.

Referring to FIG. 5, when a PDCCH block error rate (BLER) exceeds a specific threshold, a radio link failure (RLF) timer (i.e., T310 timer) is started. If the PDCCH BLER does not satisfy a predetermined reference until the T310 timer expires, an RLF may be determined to occur, and an RRC connection re-establishment procedure may be performed. The RLF may occur in a situation where a radio link has already been established between the terminal and the source base station (S505). In other cases, if the RLC of the base station (or the terminal) does not normally receive an RLC PDU from the terminal (or the base station) after performing RLC retransmissions of the RLC PDU by the maximum ARQ retransmission number, it may be determined that an RLC protocol error has occurred, and the RRC connection re-establishment procedure may be performed as in the case where the RLF occurs. The determination of a DL RLF according to the prior art may be performed by a radio link monitor (RLM) of the terminal. In a Qₒᵤₜ state (i.e., a state in which a channel quality indicator (CQI)<Qₒᵤₜ, the RLM of the terminal may determine that a physical layer out-of-synchronization (i.e., out-of-sync state) has occurred, and may start the T310 timer (generally, the Qₒᵤₜ state may mean a state in which the PDCCH BLER is 10% or more). At this time, the source base station and the target base station may prepare a handover from the source base station to the target base station (S510). Therefore, when it is determined that a DL RLF occurrence is determined during the handover from the terminal to the target base station, the terminal may perform an RRC connection re-establishment procedure to the base station so that an RLF recovery procedure is to be successfully performed. In a Qᵢₙ state after the T310 timer is started in the terminal, the terminal may determine a state (i.e., in-sync state) in which the physical layer problem is resolved, and stop the T310 timer (generally, the Qᵢₙ state may mean a state in which the PDCCH BLER is less than 2%).

On the other hand, if the terminal does not enter the Qᵢₙ state until the T310 timer expires, the RLM of the terminal may determine that an RLF has occurred (S515) (also referred to as ‘RLF detection’).

When the RLF is detected, all radio bearers (RBs) except a signaling radio bearer 0 (SRB0) may be suspended (S520). The SRB may be used for transfer of RRC signaling messages and NAS messages. The RRC signaling messages are used for signaling between the terminal and the base station, and the NAS messages are used for signaling between the terminal and a mobility management entity (MME).

After suspending all the RBs except SRB0, the terminal may perform cell search to find an optimal cell and then select a cell (S525). When the cell selection is successfully completed, the terminal may receive a master information block (MIB) and a system information block (SIB) from the newly selected cell (i.e., target base station). Thereafter, the terminal may perform a random access procedure with the new cell using the received MIB and SIB (S530). Then, the terminal may transmit an RRC connection re-establishment request message to the target base station (S535). When the target base station has context information of the terminal, the terminal may receive an RRC connection re-establishment message (or, an RRC connection re-establishment reject message if the RRC connection re-establishment request is rejected by the target base station) from the target base station (S540).

The terminal receiving the RRC connection re-establishment message may perform a radio resource configuration procedure and resume an SRB1 by re-establishing a PDCP layer and an RLC layer for the SRB1 (S545). Then, the terminal may configure lower layers to activate integrity protection and ciphering, and reactivate access stratum (AS) security (S550). Then, the terminal may transmit an RRC connection re-establishment complete message to the target base station (S555), and receive an RRC connection reconfiguration message from the target base station (S560). Then, the terminal may re-establish and resume an SRB2 and a data radio bearer (DRB) (S565).

On the other hand, when the terminal receives the RRC connection re-establishment reject message (not shown in the figure) from the target base station, the terminal may reset the MAC layer while leaving the RRC_CONNECTED state. At the same time, the terminal may stop all active timers except T320, T325, and T330, release all radio resources including the RLC entity, the MAC configuration, and the PDCP entity related to all the established RBs, and enter the RRC_IDLE state.

Meanwhile, in the RRC connection re-establishment procedure in the 3GPP LTE and LTE-A systems, a data transmission and reception disconnection time between the terminal and the base station may be generally a time from the time point at which the T310 timer is started (i.e., a time point at which the Qₒᵤₜ state is identified) to the time point at which the DRB is resumed after the RRC connection re-establishment procedure is successfully completed. Generally, the T310 timer may be set to 1 second. In the RRC connection re-establishment procedure, the data transmission and reception disconnection time is known to be about 0.8 second (800 ms), and since data received during this disconnection time cannot be transferred to the upper layer, the received data may become useless, and a data transmission latency due to this may increase.

In this case, even if the DRB is re-established and the data received from the terminal is transferred to the upper layer, the data transferred in an improper order at the PDCP layer may not be transferred to the upper layer of the PDCP layer, and thus the data received at the terminal may become useless. Also, when the DRB is re-established and resumed, the PDCP layer of the terminal receiving the data in an improper order may be implemented to transfer the corresponding data to the upper layer of the PDCP layer. However, in this case, the data transmission and reception disconnection time is hardly reduced. Next, an RRC connection re-establishment according to an embodiment of the present disclosure for solving the problem of disconnection of data transmission and reception for a long time will be described.

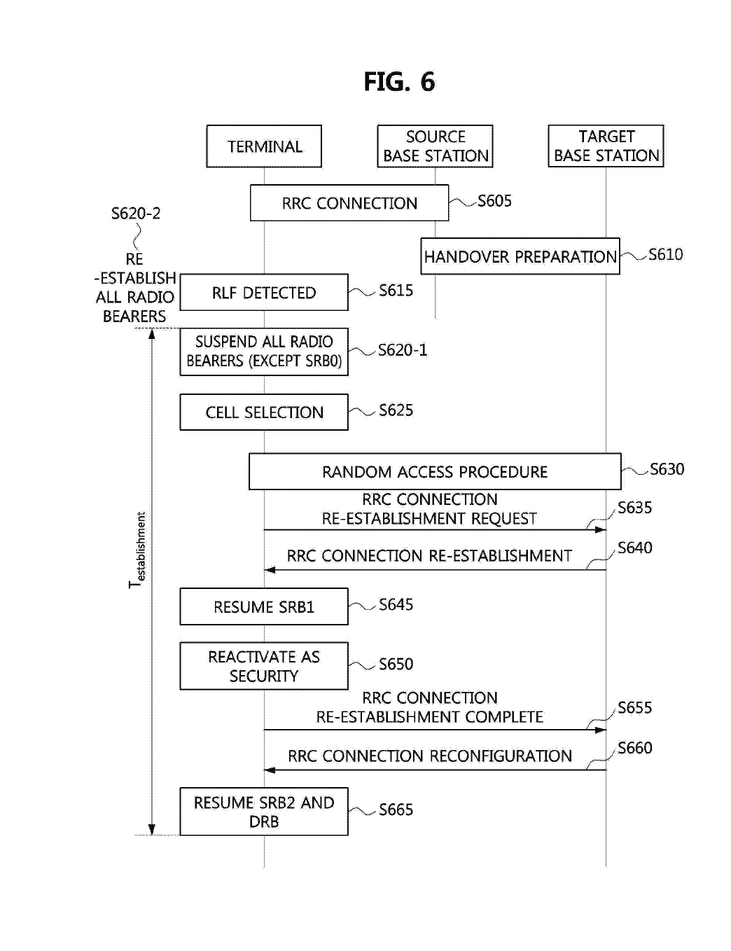

FIG. 6 is a sequence chart illustrating an RRC connection re-establishment procedure according to an embodiment of the present disclosure.

Referring to FIG. 6, when an RLF is detected according to the expiration of the RLF occurrence detection timer T310, the PDCP and RLC layers of all RBs except SRB0 may be suspended and re-established. For example, when the RLM of the terminal identifies the Qₒᵤₜ state of the DL PDCCH, it may determine that a physical layer out-of-synchronization has occurred and start the T310 timer. In an embodiment of the present disclosure, the data received while the T 310 timer runs may be transferred to the upper layer of the terminal even if the data are received in an improper order.

Specifically, an RLF may occur in a situation where a radio link has already been established between the terminal and the source base station (i.e., first base station) (S605).

Alternatively, as described above, if the RLC of the base station (or the terminal) does not normally receive an RLC PDU from the terminal (or the base station) after performing RLC retransmissions of the RLC PDU by the maximum ARQ retransmission number, it may be determined that an RLC protocol error has occurred, and the RRC connection re-establishment procedure may be performed as in the case where the RLF occurs.

In a Qₒᵤₜ state, the RLM of the terminal may determine that a physical layer out-of-synchronization (i.e., out-of-sync state) has occurred, and may start the T310 timer. At this time, the source base station and the target base station may prepare a handover from the source base station to the target base station (i.e., second base station) (S610). Therefore, when it is determined that a DL RLF occurrence is determined during the handover from the terminal to the target base station, the terminal may perform an RRC connection re-establishment procedure to the target station so that an RLF recovery procedure is to be successfully performed. When the RLF is detected, all RBs except SRB0 may be suspended (S620-1). Also, re-establishment may be performed for all the RBs (S620-2).

After suspending all the RBs except for SRB0, the terminal may perform cell search to find an optimal cell and then select a cell (S625). When the cell selection is successfully completed, the terminal may receive a MIB and a SIB from the newly selected cell (i.e., target base station). Then, the terminal may perform a random access procedure with the new cell using the received MIB and SIB (S630). Then, the terminal may transmit an RRC connection re-establishment request message to the target base station (S635). If the target base station has context information of the terminal, the terminal may receive an RRC connection re-establishment message (or, an RRC connection re-establishment reject message if the RRC connection re-establishment request is rejected by the base station) from the target base station (S640).

The terminal receiving the RRC connection re-establishment message may perform a radio resource configuration procedure and resume the SRB1 by re-establishing the PDCP layer and the RLC layer for the SRB1 (S645). Then, the terminal may configure lower layers to activate integrity protection and ciphering, and reactivate AS security (S650). Then, the terminal may transmit an RRC connection re-establishment complete message to the target base station (S655), and receive an RRC connection reconfiguration message from the target base station (S660). Then, the terminal may resume the SRB2 and the DRB (S665).

Using the RRC connection re-establishment procedure according to the above-described embodiment of the present disclosure, a data transmission and reception disconnection time between the terminal and the base station may be a time from the time point at which the T310 timer is expired and the PDCP and RLC layers of the DRB are re-established and suspended to the time point at which the DRB is resumed after the RRC connection re-establishment procedure is successfully completed. During the operation of the T310 timer, the received data may be transferred to the upper layer, thereby reducing the data communication disconnection time and reducing the data transmission delay. To this end, the RRC layer of the terminal may inform the lower PDCP or RLC layer of a time point at which data out of order is transferred to the upper layer. That is, the data transmitted from the source base station to the terminal may be transferred to the upper layer of the RLC layer at a time determined through the control of the RRC layer, and selectively transferred to the upper layer of the PDCP layer. For example, data that is relatively sensitive to delay may need to be transferred to the upper layer quickly, in which case the data can be forwarded to the upper layer of the PDCP layer.

Meanwhile, the RLC PDU transmitted by the base station may be lost in the radio channel or may not be received in the terminal for a predetermined period of time. Alternatively, the RLC PDU may not be normally received even after the terminal requests retransmission to the base station by a predetermined number of times for the RLC PDU having the same sequence number. In this case, the terminal may determine that the RLC PDU of the sequence number cannot be received. Usually, if an RLC of a transmitting side (e.g., base station or terminal) does not normally receive an RLC PDU from a receiving side (e.g., terminal or base station) after performing RLC retransmissions of the RLC PDU by the maximum ARQ retransmission number, it may be determined that an RLC protocol error has occurred, and the RRC connection re-establishment procedure may be performed as in the case where the RLF occurs. In this case, if data is not normally received even though the terminal makes a retransmission request according to a predetermined criterion, the data received from the source base station may be transferred to the upper layer of the RLC layer and selectively transferred to the upper layer of the PDCP layer. For example, data that is relatively sensitive to delay may need to be transferred to the upper layer quickly, in which case the data can be forwarded to the upper layer of the PDCP layer.

Next, an RRC connection re-establishment in a case where the terminal supports dual connectivity (DC) according to an embodiment of the present disclosure will be described.

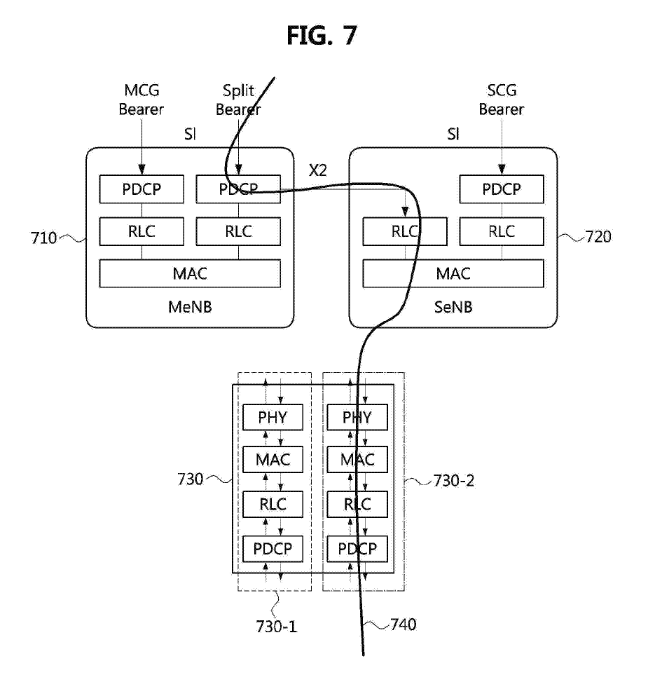

FIG. 7 is a conceptual diagram illustrating data transmission through RRC connection re-establishment of a terminal supporting dual connectivity according to an embodiment of the present disclosure.

Referring to FIG. 7, when a terminal 730 supports dual connectivity, an RLF may occur in a cell 710 of a master cell group (MCG), and a cell 720 of a secondary cell group (SCG) has a good radio link state. In this case, it may be reported by the terminal 730 to the cell 720 of the SCG that the RLF occurs in the MCG.

When an RLF occurs in the cell 710 of the MCG, if there is a radio link in which no RLF occurs among the neighboring cells of the SCG, the terminal 730 may re-establish PDCP and RLC layers of all RBs, and may not suspend all the RBs.

Specifically, when the terminal 730 supports dual connectivity, when an RLF occurs in the radio link between the terminal 730 and the cell 710 which is a cell of the MCG, the terminal 730 may inform a Master eNode B (MeNB) which is a base station of the MCG that the RLF occurs in the cell 710 of MCG through a connection 740 with a Secondary eNode B (SeNB) which is a base station of the SCG. Here, the MeNB and the SeNB may be connected via an X2 interface.

That is, the MeNB 710 may transfer data to be transmitted to the terminal 730 to the SeNB 720 through the X2 interface, and the SeNB 720 may transmit the data to the terminal 730. In this case, since the terminal supports the dual connectivity, the data may be received through a supplementary radio link processing protocol path 730-2 instead of a radio link processing protocol path 730-1 with the MeNB 710, and transferred to an upper layer.

Also, the terminal 730 may re-establish PDCP and RLC layers all RBs except SRB0, or may continuously exchange data between the terminal and the SeNB without suspending all the RBs. Also, the terminal 730 may transmit a PDCP status report to the MeNB 710 through the SeNB 720, and the MeNB 710 may retransmit a PDCP service data unit (SDU), that is determined to be retransmitted by examining the received PDCP status report, to the terminal 730.

That is, when the terminal detects an RLF or when an RLF occurs in the MeNB after a cell is selected as a cell with which an RRC connection re-established is to be performed in the RRC connection re-establishment procedure, the corresponding RLF may be reported through a radio link having a good link state which is not a radio link with the MeNB 710. As a result, the source base station MeNB 710, which is reported that the RLF occurs, may continuously exchange data with the terminal through the radio link (the radio link with the SeNB 720) in which the RLF does not occur, and thus the data transmission and reception disconnection time can be removed.

Also, the terminal 730 may report to the MeNB 710 a cell identifier (ID) of the cell of the SeNB 720 to perform the RLF occurrence report and the re-establishment after determining the cell in the cell selection step in the RRC connection re-establishment procedure. Through this procedure, the MeNB 710 may perform SN status transfer and data forwarding more quickly to the target base station SeNB 720 corresponding to the reported cell ID. Therefore, the data disconnection time may be reduced so that the terminal can receive data more quickly.

Next, an RRC connection re-establishment procedure in a case where a terminal supports carrier aggregation (CA) according to an embodiment of the present disclosure will be described.

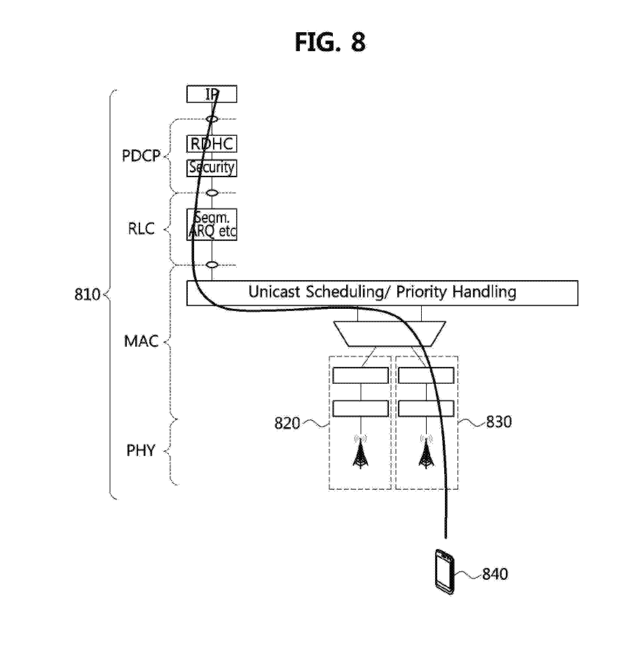

FIG. 8 is a conceptual diagram illustrating data transmission through RRC connection re-establishment of a terminal supporting carrier aggregation according to an embodiment of the present disclosure.

Referring to FIG. 8, when an RLF occurs between a terminal 840 supporting CA and a primary cell 820 of a base station 810, the terminal 840 may notify the occurrence of the RLF through a secondary cell 830 of the base station 810. The base station 810 may transmit data to be transmitted to the terminal 840 through the secondary cell 830.

The RRC connection re-establishment of the terminal supporting CA may be performed in various ways.

As a first scheme, PDCP layers and RLC layers for all DRBs may be re-established after the RRC connection re-establishment between the terminal 840 and the secondary cell 830 of the base station succeeds.

As a second scheme, the terminal 840 and the secondary cell 830 of the base station may perform data transmission and reception without suspending all RBs while re-establishing PDCP layers and RLC layers of all the RBs including SRBs and DRBs.

As a third scheme, the terminal 840 and the secondary cell 830 of the base station may re-establish remaining SRBs except SRB0, and continuously perform data transmission and reception for all the DRBs without re-establishing PDCP layers and RLC layers.

Also, the terminal 840 may transmit a PDCP status report to the base station 810, and the base station 810 receiving the PDCP status report may retransmit a PDCP SDU which needs to be retransmitted to the terminal 840 based on the PDCP status report.

Next, a PDCP PDU duplicate transmission according to an embodiment of the present disclosure will be described as another method for realizing the ultra-reliable low-latency communication.

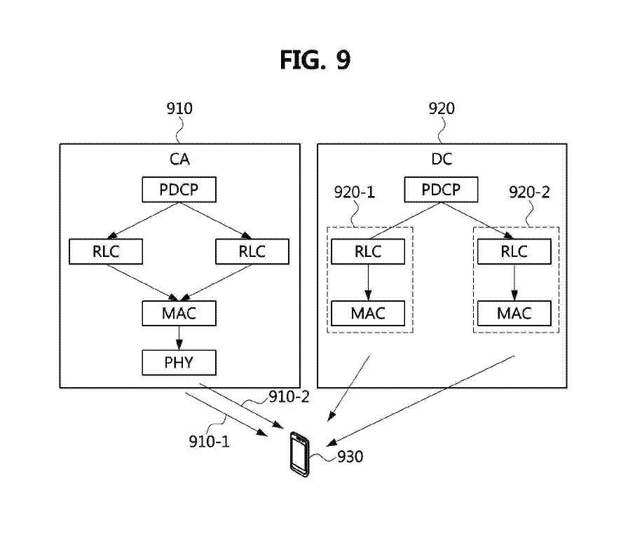

FIG. 9 is a conceptual diagram for explaining a PDCP PDU duplicate transmission according to the prior art.

Referring to FIG. 9, there are two methods of transmitting a PDCP PDU duplicately to a base station. When a duplicate transmission for a specific radio bearer (RB) is configured by the RRC layer, another RLC entity and logical channel may be added to the corresponding RB to control the duplicated PDCP PDU. Thus, duplication in the PDCP layer may mean transmitting the same PDCP PDU twice (the first being transmitted by the original RLC entity and the second being transmitted by the added RLC entity). Through such the independent transmission paths, the reliability of the packet transmission can be increased, and the transmission latency in the packet transmission can be reduced, thereby playing a large role in implementing the URLLC function.

When the PDCP duplicate transmission is performed, the original PDCP PDU and the duplicated PDCP PDU are not transmitted on the same carrier. Two different logical channels may belong to the same MAC entity or may belong to different MAC entities. In case of the terminal 930 supporting DC, PDCP PDUs may be received duplicately through different base stations 920-1 and 920-2. In case of the terminal supporting CA, the PDCP PDUs may be received through different carriers 910-1 and 910-2. Through this, the reliability and latency requirements for the implementation of URLLC can be met.

However, in the case of such the PDCP PDU duplicate transmission, when data is normally received at the terminal through the one RLC entity, redundant transmission of the data through another RLC entity may cause waste of radio resources and latency of data transmission. Next, a PDCP PDU duplicate transmission method according to an embodiment of the present disclosure for preventing such the data transmission latency due to the duplicate transmission will be described.

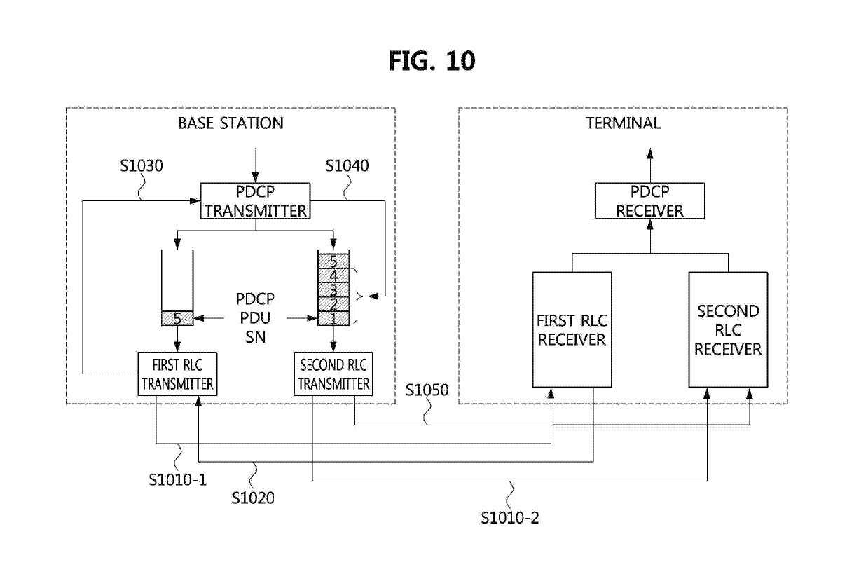

FIG. 10 is a conceptual diagram illustrating a PDCP PDU duplicate transmission method according to an embodiment of the present disclosure.

Referring to FIG. 10, there is illustrated a control signal and data transmission and reception procedure for reducing waste of radio resources and data transmission latency when a base station performs a PDCP PDU duplicate transmission to a terminal. The PDCP PDU duplicate transmission according to an embodiment of the present disclosure supposes a situation in which a PDCP PDU of the base station is duplicated to a first RLC transmitter and a second RLC transmitter (however, the embodiment of the present disclosure is not so limited thereto). First, the first RLC transmitter of the base station may transmit PDCP PDUs corresponding to sequential numbers (SNs) 1 to 4 among PDCP PDUs to be transmitted to a first RLC receiver of the terminal (S1010-1). Here, they may be transmitted in form of RLC PDUs, and this may be commonly applied to the below description on the embodiment of FIG. 10. In the present embodiment, it may be assumed that PDCP PDUs (i.e., SNs 1 to 4) transmitted in the form of four RLC PDUs from the first RLC transmitter of the base station to the first RLC receiver of the terminal have been successfully received at the first RLC receiver of the terminal. Also, the second RLC transmitter of the base station may transmit PDCP PDUs corresponding to SNs 1 to 4 to a second RLC receiver of the terminal (as described above, transmitted in the form of RLC PDUs) (S1010-2).

In the present embodiment, the four PDCP PDUs (SNs 1 to 4) transmitted from the second RLC transmitter of the base station to the second RLC receiver of the terminal may be assumed to be missing and not received at the second RLC receiver of the terminal. In this case, when the PDCP PDUs are duplicately transmitted, a PDCP transmitter of the base station may notify the lower RLC layers (a first RLC layer and a second RLC layer) of the duplicate transmission, and the RLC layers may configure polling for the RLC PDUs transmitted duplicately so that the RLC receiver of the terminal can quickly transmit a status PDU to the base station.

The first RLC receiver of the terminal that has normally received the PDCP PDUs corresponding to the four consecutive SNs may inform the first RLC transmitter of the base station that the PDCP PDUs corresponding to the SNs 1 to 4 have been normally transferred to the first RLC receiver through a status PDU (S1020).

The first RLC transmitter of the base station that has received the status PDU from the terminal may inform the PDCP transmitter, which is an upper layer of the base station, that the PDCP PDUs corresponding to the SNs 1 to 4 have been normally transmitted to the first RLC receiver (S1030). Base on the information, the PDCP transmitter of the base station may determine that it does not need to duplicately transmit the PDCP PDUs (SNs 1 to 4) through the second RLC transmitter, and request the second RLC transmitter to discard the PDCP PDUs (SNs 1 to 4) (S 1040). Here, if the second RLC transmitter has not yet transmitted to the terminal the corresponding RLC PDUs (i.e., the RLC PDUs corresponding to the PDCP PDUs ranging from SN 1 to SN 4), the second RLC transmitter may discard RLC service data units (SDUs) for the corresponding RLC PDUs.

On the other hand, even if the base station has transmitted the RLC PDUs corresponding to the PDCP PDUs ranging from SN 1 to SN 4 to the terminal, the base station may discard the RLC SDUs and stop the transmission of the RLC PDUs. In this case, since an out-of-order sequence is generated in the receiving terminal and reordering is performed, the data forwarding to the upper layer of the terminal may be delayed. In order to prevent this, the RLC SDUs may be discarded and the RLC PDUs may be transmitted without payload data in order to allow transmission of the RLC PDUs using a minimum amount of radio resources. Here, the payload may be RLC SDUs. Alternatively, an RLC control PDU including information indicating that the RLC PDUs have been discarded. Here, the RLC control PDU may include SNs of the discarded PDUs.

For this, the second RLC transmitter may transmit the RLC PDUs each of which comprise only an RLC header without payload data to the second RLC receiver of the terminal (S1050). The second RLC receiver, which has received the RLC PDU including only the RLC header without payload data, may confirm that the corresponding RLC SDUs are discarded.

Next, data transmission using a different quality of service (QoS) setting according to an embodiment of the present disclosure will be described as another method for realizing ultra-reliable low-latency communication.

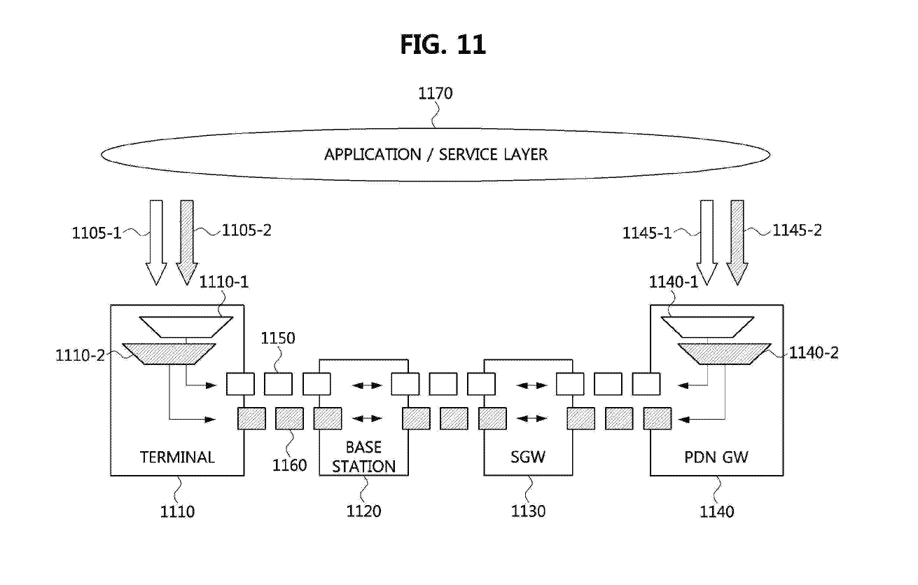

FIG. 11 is a conceptual diagram illustrating data transmission using QoS settings per IP flow according to the prior art.

Referring to FIG. 11, a terminal 1110 may transmit and receive data to and from a public data network gateway (PDN-GW) 1140 via a base station 1120 and a serving gateway (SGW) 1130.

A collection of IP packets having the same transmission and reception IP addresses, transmission protocol, and transmission and reception ports may be referred to as an IP flow.

Each IP flow may be mapped to one bearer, and one bearer may be mapped to one or more IP flows. The bearer, as a virtual concept as described above, may define how data and signaling of the terminal are handled during transmission and reception through the network. The network handles the data according to the characteristics of the data. The RB may be classified into SRB and DRB. As described above, the SRB may be used for transferring control plane traffic such as RRC signaling messages and NAS messages, and the DRB may be used for transferring user plane traffic (user plane traffic is also referred to as user data). The DRB may be used to transfer the IP packets.

The IP flow may be mapped to one bearer in the RRC layer, and one bearer may be mapped to one logical channel in the RLC/MAC layer. The same QoS may be applied to all IP packets of the bearer and logical channels associated with one IP flow. In the 3GPP LTE and LTE-A mobile communication systems, the MAC layer determines transmission priority and the amount of transmission data according to the priority of the logical channel. A downlink traffic flow template (TFT) of the terminal and a downlink TFT of the PDN-GW may separate IP packets for each IP flow through a packet filter and transmit the separated IP packets to a counterpart communication node in the form of the bearer. In this case, the bearer between the terminal 1110 and the base station 1120 may have a form of a radio bearer, the bearer between the base station 1120 and the SGW 1130 may have a form of an Si bearer, and the bearer between the SGW 1130 and the PDN-GW 1140 may have a form of an S5/S8 bearer.

In FIG. 11, a first uplink traffic flow aggregate 1105-1 may be transferred to the PDN-GW 1140 in form of an RB 1150 via a packet filter 1110-1 associated with an uplink TFT of the terminal. Also, a second uplink traffic flow aggregate 1105-2 may be transferred to the PDN-GW 1140 in form of an RB 1160 via a packet filter 1110-2 associated with the uplink TFT of the terminal.

Conventionally, a TFT rule used in the uplink TFT and the downlink TFT may manage IP packets on IP flows by classifying the IP packets according to 5-tuple including source IP address, destination IP address, transport protocol, source transport port, and destination transport port. In this case, all the IP packets in one IP flow may be subjected to the same QoS, and when a congestion occurs in the IP flow, the RLC layer may discard IP packet having the earliest generation time (i.e., oldest IP packet). This may be due to a request of the PDCP layer.

However, if a relatively important IP packet is discarded in one IP flow, it may significantly affect overall performance. If the IP packet is discarded without regard to the importance of the IP packet due to the congestion, the overall communication service quality may deteriorate and the data transmission latency may increase. Next, data transmission using different QoS settings according to an embodiment of the present disclosure for preventing data transmission latency will be described.

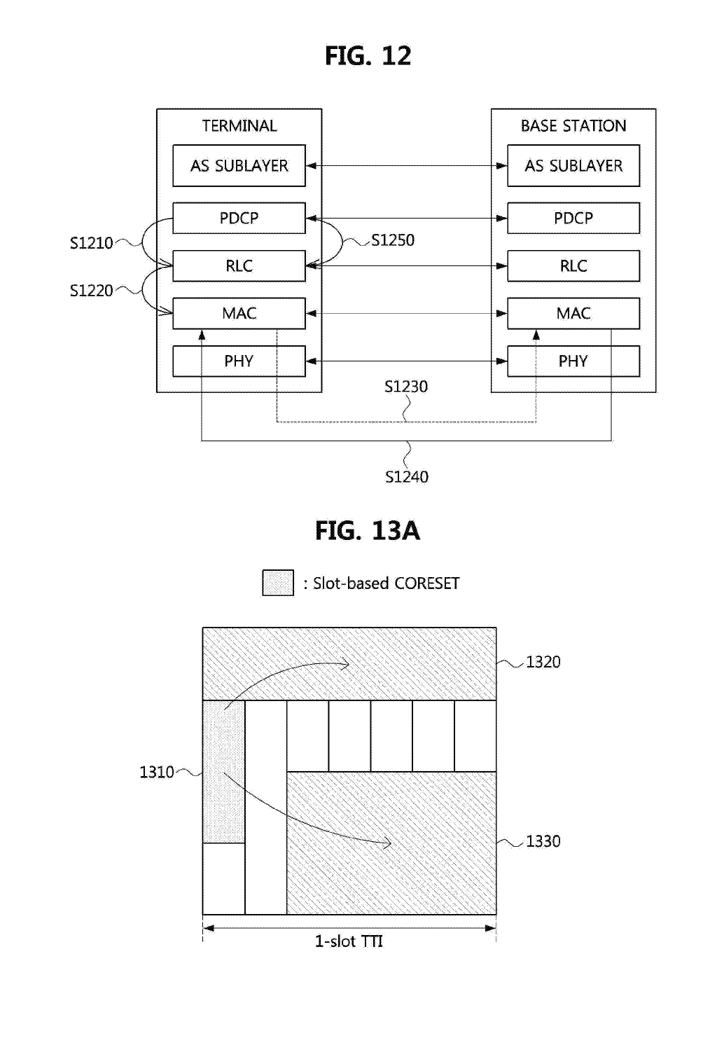

FIG. 12 is a conceptual diagram illustrating data transmission using QoS settings per IP flow according to an embodiment of the present disclosure.

Referring to FIG. 12, in case of IP packets to which different QoS settings should be applied in one IP flow, it is shown that the IP packets to which the different QoS settings should be applied in one bearer are processed separately. When IP packets in one IP flow are mapped to different bearers and logical channels, the IP packets may be transmitted to the upper layer of the counterpart communication node in a state where a data sequence of the IP packets is not matched, and the performance may be deteriorated. Therefore, in order to solve this problem, it is possible to apply different QoS settings to IP packets in one bearer for IP packets to which different QoS settings are applied in one IP flow.

To this end, it is possible to determine importance of an IP packet transmitted from an upper layer to the lower PDCP layer of the terminal according to a predetermined importance determination criterion. The PDCP layer may transmit determined importance information to the RLC layer (S1210). For example, in case of a 2-step importance determination criterion (distinguishes importance of data by setting a significant data flag bit or the like), a PDCP PDU may be transmitted to the RLC layer by marking that critical data is included therein.

The RLC layer receiving the RLC PDU may transmit the RLC PDU including the importance information to the MAC layer (S1220). For example, in the case of the 2-step importance determination criterion described above, the RLC layer may notify the MAC layer that the RLC PDU is waiting to be transmitted in the RLC buffer by marking that critical data is included therein.

The MAC layer of the terminal may then request resource allocation for UL transmission by transmitting a buffer status report (BSR) to the base station for rapid data communication according to a separate processing criterion in the case that the data indicated as the important data according to the importance information is received from the upper layer (S1230). For the important data, the BSR may be triggered immediately. The base station receiving the BSR from the terminal may give a UL grant to allow the important data to be transmitted (S1240).

According to the above-described procedure, the terminal may be allocated a UL radio resource and may transmit the PDCP PDU to the base station, and there may be the PDCP PDU that cannot be transmitted for a predetermined period of time. In this case, the PDCP layer may request the RLC layer to discard a RLC SDU associated with the PDCP PDU that has not been transmitted for the predetermined period of time according to the importance of the PDCP PDU (S1250). That is, the RLC layer may discard the RLC SDU associated with the non-important IP packet. However, the RLC layer may not discard the RLC SDU associated with the important IP packet according to the importance of the IP packet, so that the transmission latency of the important data can be reduced and the quality degradation of the communication service can be prevented. The importance determination criterion may be configured in advance and may be provided to the terminal from the base station. Alternatively, the terminal may configure its importance determination criterion.

In another embodiment of the present disclosure, different QoS settings may be applied by mapping IP packets to which different QoS settings should be applied in one IP flow to different bearers and logical channels on a packet-by-packet basis. In addition to the TFT rule of 5 tuple (source IP address, destination IP address, transport protocol, source transport port, and destination transport port), a separate protocol header may be added. For example, an IP packet having an acknowledgment (ACK) bit set in a transmission control protocol (TCP) flag of a TCP header may be mapped to a logical channel having a high priority.

In yet another embodiment of the present disclosure, a plurality of subchannels may be placed in one logical channel to separately process packets to which different QoS settings should be applied. That is, the subchannels for the logical channels associated with each QoS may be allocated differently. Accordingly, the MAC layer may preferentially transmit data of a subchannel to which the high priority packet is allocated among the data in the RLC buffer. The information on the subchannels does not need to be informed to the base station since the information is related only to the internal operation of the terminal.

A priority and a discard timer of each IP packet according to the QoS difference may be configured differently for the packets to which different QoS settings should be applied. That is, QoS parameters are differentiated. For example, different priorities and different discard timers may be set for the respective subchannels for a logical channel, and applied to IP packets assigned to the respective subchannels. Here, the configuration of the QoS parameters may be controlled by the RRC layer.

Specifically, in case of a TCP packet, when there are a plurality of ACK packets to be transmitted, discarding previous ACK packets except an ACK packet generated most recently (later) and transmitting a new ACK packet may increase the TCP performance. The PDCP layer may request the RLC layer to discard the old TCP ACK packets by requesting the RLC layer to discard the RLC SDU before expiration of the discard timer according to necessity. Next, a mini-slot PDCCH monitoring method according to an embodiment of the present disclosure for preventing data transmission latency will be described.

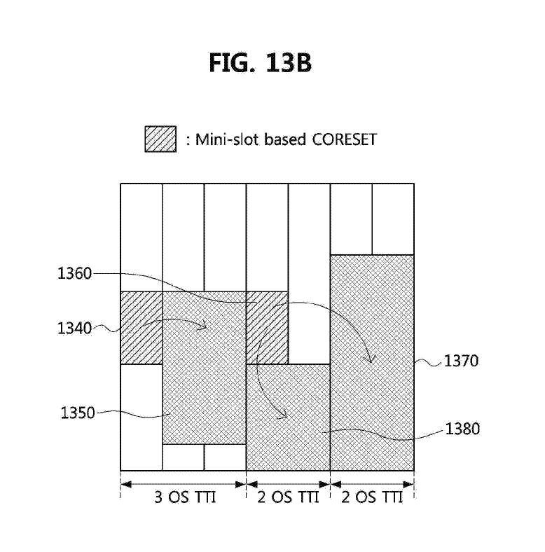

FIG. 13A is a conceptual diagram illustrating a slot-based PDCCH monitoring according to the prior art, and FIG. 13B is a conceptual diagram illustrating a PDCCH monitoring when a mini-slot according to the prior art is applied.

Referring to FIGS. 13A and 13B, when a PDCCH is transmitted through a mini-slot based TTI in units of symbols, which is different from a conventional slot based TTI, an increase in the number of monitoring times due to an increase in the number of PDCCH candidates is illustrated.

As described above, since the 5G mobile communication system is aimed to support a wide bandwidth from 5 MHz to 400 MHz, unlike a conventional maximum bandwidth of 20 MHz and a single subcarrier interval of 15 kHz. Therefore, it is difficult to efficiently manage the entire wide bandwidth with only single subcarrier interval. Therefore, a method of differentially applying subcarrier intervals according to the frequency bandwidth has been studied. Also, a method of applying slots and mini-slots according to the subcarrier intervals has been studied. When a large subcarrier interval is used, the length of one slot becomes shorted in inverse proportion to the large subcarrier interval so that the transmission latency in the radio channel can be reduced. This is essential for the implementation of the URLLC required in the 5G mobile communication system as described above. In addition to the conventional slot-based scheduling, a mini-slot (a slot comprising 2, 4 or 7 OFDM symbols) based scheduling is being studied.

Referring to FIGS. 13A and 13B, the mini-slot based PDCCH monitoring may be performed using one or more mini-slot PDCCHs 1340 and 1360 unlike the conventional slot-based PDCCH monitoring (i.e., one PDCCH 1310 per slot includes downlink control information for one or more RBs 1320 and 1330). Therefore, PDCCH occasions for receiving the downlink control information may be generated more frequently, so that the terminal performs the PDCCH monitoring more frequently. Here, the first mini-slot PDCCH 1340 may include downlink control information for a first RB 1350 and the second mini-slot PDCCH 1360 may include a second RB 1370 and a third RB 1380.

Although the data transmission latency can be reduced due to the mini-slot based PDCCH monitoring, the power consumption of the terminal may increase due to the increase in the number of PDCCH monitoring times of the terminal. Also, as described above, in the 5G mobile communication system, since a frequency bandwidth of several tens of times should be supported, the number of PDCCH candidates in the frequency domain also increases, and the number of blind decoding is also increased. Next, a mini-slot based PDCCH monitoring method according to an embodiment of the present disclosure for solving the problem of mini-slot based PDCCH monitoring according to the prior art will be described.

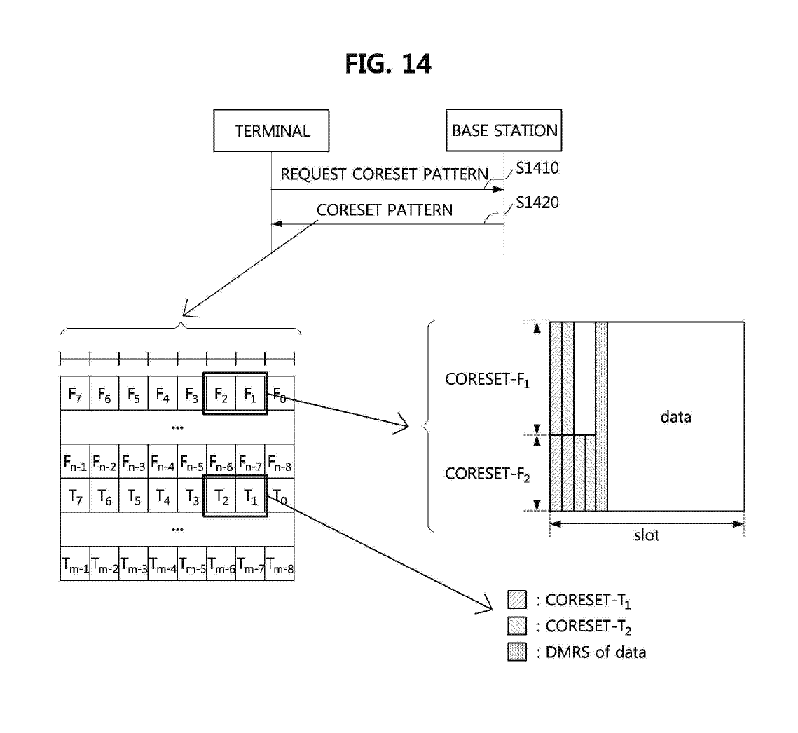

FIG. 14 is a sequence chart for explaining a mini-slot based PDCCH monitoring according to an embodiment of the present disclosure.

Referring to FIG. 14, a terminal performing the mini-slot based PDCCH monitoring may request PDCCH occasion pattern information to a base station, and the base station may transmit the PDCCH occasion pattern information to the terminal in response to the request. The base station may previously have information on a control resource set (CORESET) pattern to which PDCCH occasions are to be allocated.

The information on the CORESET pattern may have information on various PDCCH occasion allocations in a manner of combining information on N resource sets in the frequency domain and information on M resource sets in the time domain. The terminal may monitor the PDCCH occasions only for a part of a PDCCH allocation region by referring to the information on the CORESET pattern received from the base station, thereby reducing power consumption by not performing blind decoding on the unnecessary region. Specifically, the terminal may request the information on the CORESET pattern to the base station (S1410). The base station receiving the request may transmit to the terminal the information on the CORESET pattern allocated to the terminal (S1420). In the embodiment of the present disclosure shown in FIG. 14, the CORESET pattern including frequency domains F₁ and F₂ and time domains T₁ and T₂ is allocated to the terminal, but the embodiment of the present disclosure is not limited thereto. Here, the request of the information on the CORESET pattern and the information on the CORESET pattern may be transmitted through RRC signaling messages and/or MAC control elements (CEs).

When the terminal receives the information on the CORESET pattern, the terminal may monitor only the PDCCH occasions belonging to the corresponding CORESET. The base station may determine the CORESET pattern and transmit it to the terminal, but the terminal may request the base station for the CORESET pattern desired by the terminal. The base station receiving the request may directly allocate the CORESET pattern to the terminal, or may inform the terminal of the CORESET pattern allocated considering CORESET patterns allocated to other terminals.

In addition, the base station and the terminal may activate or deactivate the mini-slot based PDCCH occasions in the frequency domain and time domain. For example, the base station may deactivate the mini-slot based PDCCH occasion monitoring and notify the terminal of related information as needed. The terminal may determine that the mini-slot based PDCCH occasions are deactivated when allocation information in all frequency domains and time domains is deactivated in the CORESET pattern received by the terminal. Also, the terminal may request the base station to deactivate the mini-slot based PDCCH occasions, and the base station receiving the request may deactivate the mini-slot based PDCCH monitoring and notify the terminal of the result.

Alternatively, a resource set may be applied to a physical downlink shared channel (PDSCH) and/or a physical uplink shared channel (PUSCH) in the same manner as the PDCCH. In this case, PDSCH and/or PUSCH resource set patterns may be allocated according to a request of the terminal, and uplink and downlink data transmission and reception may be performed using PDSCH resources in a specific frequency domain and a specific time domain and/or PUSCH resources in a specific frequency domain and a specific time domain.

Meanwhile, a switching form the mini-slot based TTI operation to the slot based TTI operation may be performed, and conversely a switching form the slot based TTI operation to the mini-slot based TTI operation may be performed. When switched from the mini-slot based TTI operation to the slot based TTI operation, the number of hybrid automatic repeat request (HARQ) processes being performed in the mini-slot based TTI operation may be greater than the number of HARQ processes being performed in the slot based TTI operation. In this case, although a HARQ retransmission is required, HARQ retransmission may not be performed using a HARQ process in the slot-based TTI operation, and data communication performance may be degraded. In order to solve such the problem, if the number of HARQ processes of the mini-slot based TTI operation during the switching operation is larger than the number of HARQ processes in the slot based TTI operation, for data for which the HARQ retransmission is required before the switching, if the HARQ process of the slot-based TTI operation after the switching is available, HARQ retransmission may be performed in the form of initial transmission using the available HARQ process.

The embodiments of the present disclosure may be implemented as program instructions executable by a variety of computers and recorded on a computer readable medium. The computer readable medium may include a program instruction, a data file, a data structure, or a combination thereof. The program instructions recorded on the computer readable medium may be designed and configured specifically for the present disclosure or can be publicly known and available to those who are skilled in the field of computer software.

Examples of the computer readable medium may include a hardware device such as ROM, RAM, and flash memory, which are specifically configured to store and execute the program instructions. Examples of the program instructions include machine codes made by, for example, a compiler, as well as high-level language codes executable by a computer, using an interpreter. The above exemplary hardware device can be configured to operate as at least one software module in order to perform the embodiments of the present disclosure, and vice versa.

While the embodiments of the present disclosure and their advantages have been described in detail, it should be understood that various changes, substitutions and alterations may be made herein without departing from the scope of the present disclosure.

What is claimed is:

1. An operation method of a terminal in a mobile communication system, the operation method comprising:
starting a T310 timer when a physical layer out-of-synchronization occurs in a physical downlink control channel (PDCCH) transmitted from a first base station;
confirming that a radio link failure (RLF) occurs when the PDCCH does not transition to a physical layer in-sync state until the T310 timer expires;
performing re-establishment of packet data convergence protocol (PDCP) layers and a radio link control (RLC) layers for all radio bearers except a signaling radio bearer 0 (SRB0);
suspending all the radio bearers except the SRB0;
performing a radio resource control (RRC) connection re-establishment with a second base station selected through cell selection; and
resuming all the radio bearers when the RRC connection re-establishment with the second base station succeeds.

2. The operation method according to claim 1, further comprising transferring data transferred from the first base station to an upper layer of the RLC layer at a time determined through control of a RRC layer, and selectively transferring the data to an upper layer of the PDCP layer.

3. The operation method according to claim 1, further comprising, when data is not normally received in spite of a retransmission request to the first base station according to a predetermined criterion, transferring data transferred from the first base station to an upper layer of the RLC layer, and selectively transferring the data transferred from the first base station to an upper layer of the PDCP layer.

4. The operation method according to claim 1, further comprising, when an RLF occurs with the first base station, transmitting information indicating the RLF to the first base station through the second base station.

5. The operation method according to claim 4, further comprising transmitting information indicating an identifier (ID) of the second base station selected through cell selection to the first base station.

6. The operation method according to claim 1, further comprising transmitting information indicating the RLF to the first base station through a secondary cell carrier, wherein the first base station is a master base station for carrier aggregation.

7. The operation method according to claim 1, further comprising transmitting information indicating the RLF to the first base station through a secondary cell group (SCG), wherein the first base station is a master base station for dual connectivity.

8. The operation method according to claim 7, further comprising:
performing re-establishment of PDCP layers and RLC layers of all radio bearers excluding an SRB0 with the master base station; and
performing data transmission and reception with the master base station without suspending all the radio bearers except the SRB0.

9. An operation method of a terminal in a mobile communication system, the operation method comprising:
receiving, by a first radio link control (RLC) receiver and a second RLC receiver, a same data respectively transmitted from a first RLC transmitter and a second RLC transmitter of a base station;
transmitting information indicating normal reception to the first RLC transmitter that has transmitted the data when at least one of the first RLC receiver and the second RLC receiver normally receives the data; and
receiving, by at least one of the first RLC receiver and the second RLC receiver, an RLC protocol data unit (PDU) including a sequence number of a discarded RLC PDU from at least one of the first RLC transmitter and the second RLC transmitter that has not received the information indicating normal reception.

10. The operation method according to claim 9, further comprising receiving, by at least one of the first RLC receiver and the second RLC receiver that has not transmitted the information indicating normal reception, an RLC PDU comprising only an RLC header from at least one of the first RLC transmitter and the second RLC transmitter that has not received the information indicating normal reception.

11. The operation method according to claim 9, wherein a packet data convergence protocol (PDCP) layer of the base station informs the first RLC transmitter and the second RLC transmitter that a PDCP PDU of the PDCP layer is duplicated, and set a polling bit in an RLC PDU including the PDCP PDU.

12. An operation method of a terminal in a mobile communication system, the operation method comprising:
transmitting a packet data convergence protocol (PDCP) protocol data unit (PDU) including information on an importance per Internet Protocol (IP) packet to a radio link control (RLC) layer;
transmitting an RLC PDU including the information on the importance per IP packet to a medium access control (MAC) layer;
transmitting a buffer status report (BSR) to a base station;
receiving an uplink grant from the base station; and
performing discard of the RLC PDU based on the importance per IP packet according to a predetermined criterion when the PDCP PDU to be transmitted through an uplink radio resource allocated through the uplink grant is not transmitted for a predetermined period of time.

13. The operation method according to claim 12, wherein Quality of Service (QoS) is assigned to each packet differentially according to the importance per IP packet.

14. The operation method according to claim 12, wherein the MAC layer immediately triggers the BSR when data having high importance exists.

15. The operation method according to claim 12, wherein, when a plurality of acknowledgement (ACK) packets exist for a transmission control protocol (TCP) connection to be transmitted to the base station, the PDCP layer discards ACK packets other than a most recently generated ACK packet.

16. The operation method according to claim 13, wherein a subchannel is assigned to each logical channel for each IP packet to which QoS is assigned according to the importance information per IP packet.

17. The operation method according to claim 16, wherein a different priority and a discard timer are configured for each subchannel.
